(19) United States
(12) Patent Application Publication
(10) Pub. No.: US 2023/0114160 A1
(43) Pub. Date: Apr. 13, 2023

(54) MONITORING DEVICE, MONITORING METHOD, AND RECORDING MEDIUM

(71) Applicant: NEC Corporation, Minato-ku, Tokyo (JP)

(72) Inventors: Satoshi HIRATA, Tokyo (JP); Hajime Yamashita, Tokyo (JP); Genki Yamamoto, Tokyo (JP); Masafumi Shibata, Tokyo (JP); Dai Hashimoto, Tokyo (JP); Takahiro Kimoto, Tokyo (JP); Youhei Takahashi, Tokyo (JP)

(73) Assignee: NEC Corporation, Minato-ku, Tokyo (JP)

(21) Appl. No.: 17/908,378

(22) PCT Filed: Mar. 31, 2020
(86) PCT No.: PCT/JP2020/014891

§ 371 Date: Aug. 31, 2022

(51) Int. Cl. G06V 20/40; G06V 20/52; G08B 21/00

(52) U.S. Cl. CPC G06V 20/44; G06V 20/52; G08B 21/00

(57) ABSTRACT

The present invention reduces the amount of processing related to the analysis of video data. A detection time determination unit (11) determines a detection time for detecting a second event before or after a first event in time series from the video data on the basis of a time when the first event is detected from the video data, and an event detection unit (12) detects the second event from the video data in the detection time.

### TECHNICAL FIELD

The present invention relates to a monitoring device, a monitoring method, and a recording medium, and more particularly to a monitoring device, a monitoring method, and a recording medium that monitor a monitoring target area using video data acquired from a camera.

### BACKGROUND ART

A related technique analyzes video data obtained by imaging a monitoring target area by a monitoring camera (alternatively, it is also referred to as a street camera or a security camera), and detects an unusual behavior of a person different from usual and an event such as a suspicious object based on an analysis result. The monitoring target area is a place where an unspecified large number of people gather, and is, for example, a station, a shopping center, or a downtown. A related technique notifies a monitoring person, such as a police officer or security guard, of an alert when an unusual behavior or suspicious object is detected. For example, Patent Literature 1 describes that a notification destination of an alert is determined based on a risk level of a detected event.

In a related technique, a monitoring camera installed in a monitoring target area detects an event (first event) based on a difference between consecutive image frames of video data. On the other hand, a server that receives the video data from the monitoring camera detects an event (second event) from each image frame of the video data by a method such as deep learning.

### CITATION LIST

### Patent Literature

[PTL 1] JP 2019-152943 A

### SUMMARY OF INVENTION

### Technical Problem

In the related art, since the server analyzes the entire video data generated by the monitoring camera (that is, video data related to the entire period) using an advanced method, a processing capability of the server is greatly loaded. In order to reduce the processing amount of the server, an efficient video data analysis method is required.

The present invention provides an efficient video data analysis method for reducing a processing amount related to analysis of video data.

### Solution to Problem

A monitoring device according to an aspect of the present invention includes a detection time determination means configured to determine, based on a time point at which a first event is detected from video data, a detection time for detecting, from the video data, a second event before or after the first event in time series, and an event detection means configured to detect the second event from the video data in the detection time.

A monitoring method according to an aspect of the present invention is a monitoring method by a monitoring device, and includes determining, based on a time point at which a first event is detected from video data, a detection time for detecting, from the video data, a second event before or after the first event in time series, and detecting the second event from the video data in the detection time.

A recording medium according to an aspect of the present inventio stores a program for causing a computer to execute determining, based on a time point at which a first event is detected from video data, a detection time for detecting, from the video data, a second event before or after the first event in time series, and detecting the second event from the video data in the detection time.

### Advantageous Effects of Invention

According to an aspect of the present invention, it is possible to reduce a processing amount related to analysis of video data.

### BRIEF DESCRIPTION OF DRAWINGS

FIG. 1 is a diagram schematically illustrating a configuration of a system including a monitoring device according to any one of first to fourth example embodiments.

FIG. 2 is an example of one image frame of video data generated by a camera included in a system according to all example embodiments.

FIG. 3 is a block diagram illustrating a configuration of a monitoring device according to the first example embodiment.

FIG. 4 schematically illustrates an example of video data configured by a plurality of image frames.

FIG. 5 is a flowchart illustrating an example of a flow of processing executed by each unit of the monitoring device according to the first example embodiment.

FIG. 6 is a block diagram illustrating a configuration of a monitoring device according to the second example embodiment.

FIG. 7 is a flowchart illustrating a flow of processing executed by each unit of the monitoring device according to the second example embodiment.

FIG. 8 is a block diagram illustrating a configuration of a monitoring device according to the third example embodiment.

FIG. 9 illustrates an example of association between a second event in learning data and two candidates for a first event.

FIG. 10 is a flowchart illustrating a flow of processing executed by each unit of the monitoring device according to the third example embodiment.

FIG. 11 is a block diagram illustrating a configuration of a monitoring device according to the fourth example embodiment.

FIG. 12 is a diagram illustrating a hardware configuration of the monitoring device according to any one of the first to fourth example embodiments.

### EXAMPLE EMBODIMENT

### Common to All Example Embodiments

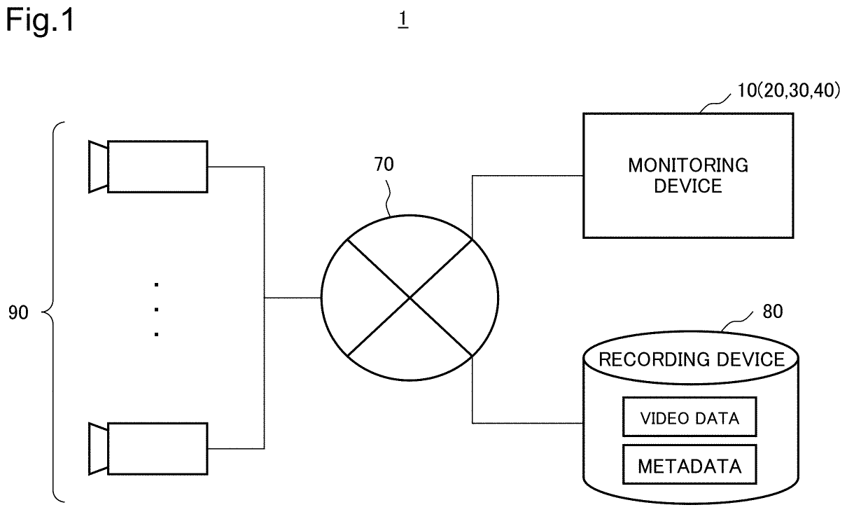

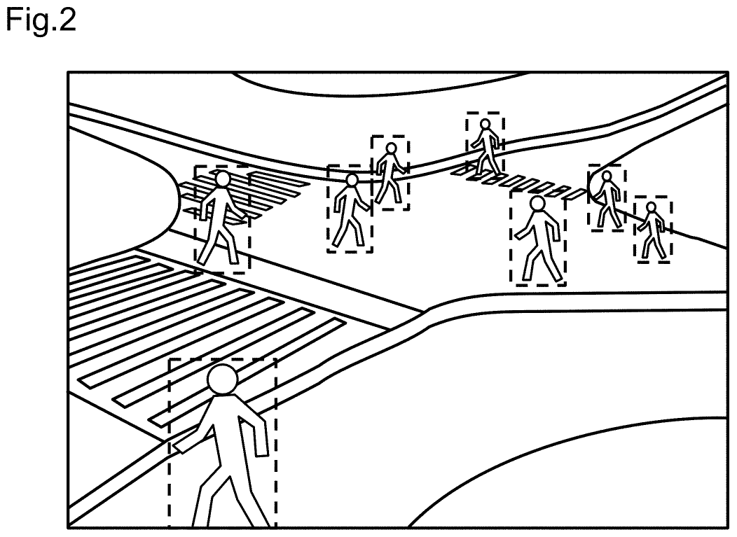

A configuration applied to a first or second example embodiment to be described later will be described with reference to FIGS. 1 and 2.

### System 1

FIG. 1 schematically illustrates a configuration of a system 1 according to all example embodiments described below. As illustrated in FIG. 1, the system 1 includes a monitoring device 10, a recording device 80, and one or a plurality of cameras 90. In the system 1, the monitoring device 10, the recording device 80, and one or the plurality of cameras 90 are communicably connected via a network 70. The system 1 may include the monitoring device 20, 30, or 40 according to any one of the second to fourth example embodiments instead of the monitoring device 10 according to the first example embodiment. Alternatively, the system 1 may include a motion sensor instead of the camera 90 or in addition to the camera 90.

In an example, the system 1 is used to monitor a predetermined area (referred to as a monitoring target area). In the system 1, the monitoring device 10 analyzes video data obtained by one or the plurality of cameras 90 imaging the inside of the monitoring target area. As a result, the monitoring device 10 detects an unusual behavior of a person different from usual and an event such as a suspicious object. The one or the plurality of cameras 90 accumulates the generated video data to transmit the accumulated video data to the monitoring device 10 every predetermined time (for example, 30 seconds) or every time an event is detected.

One or the plurality of cameras 90 have a function of detecting a moving object as an event by analyzing video data. More specifically, the one or the plurality of cameras 90 detect that a person, a bicycle, an automobile, an animal, and other objects are moving as an event based on a difference between image frames of the video data. Hereinafter, a case where the system 1 includes only one camera 90 (alternatively, only one camera 90 is activated) will be described.

FIG. 2 illustrates an example of an image frame of video data generated by the camera 90. In the image frame illustrated in FIG. 2, there is a plurality of persons in the intersection. A rectangle surrounding each person indicates an area of a walking person (an example of a moving object) detected as an event by an analysis unit (not illustrated) of the camera 90.

The analysis unit of the camera 90 transmits information indicating the analysis result of the video data to the monitoring device 10 via the network 70. The camera 90 stores information indicating the analysis result of the video data in the recording device 80 as metadata regarding the video data. The recording device 80 may be included in the monitoring device 10, 20, 30, or 40.

### First Example Embodiment

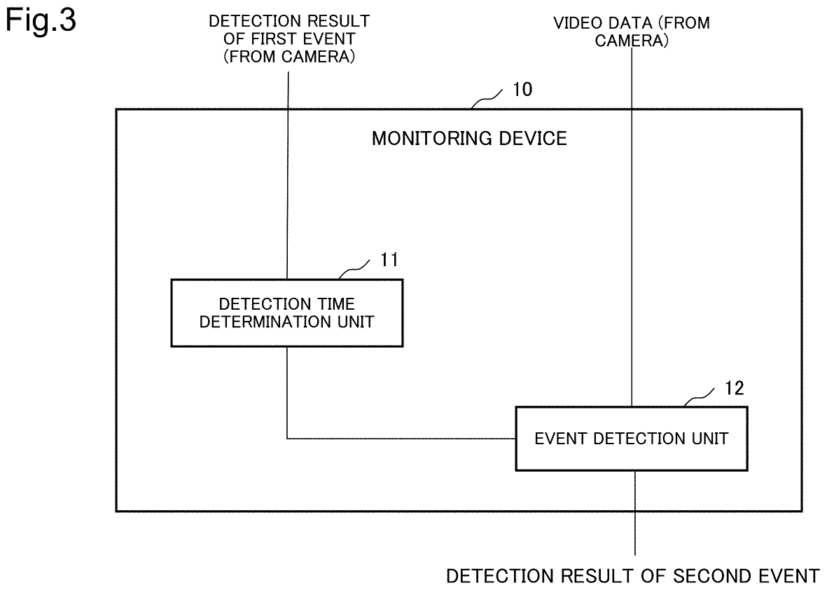

The first example embodiment will be described below with reference to FIGS. 3 to 5.

### Monitoring Device 10

A configuration of the monitoring device 10 according to the first example embodiment will be described with reference to FIG. 3. FIG. 3 is a block diagram illustrating a configuration of the monitoring device 10.

As illustrated in FIG. 3, the monitoring device 10 includes an event detection unit 12 and a detection time determination unit 11.

Based on the time point at which the first event is detected from the video data, the detection time determination unit 11 determines a detection time for detecting a second event before or after the first event in time series from the video data. The detection time determination unit 11 is an example of a detection time determination means. The detection time may be a certain period before the time point when the first event is detected, or may be a certain period after the time point when the first event is detected. Alternatively, the detection time may include a time point at which the first event is detected.

An example of the detection time determination unit 11 will be described. First, the detection time determination unit 11 acquires a predetermined detection result of the first event from the camera 90. Alternatively, the detection time determination unit 11 may acquire the analysis result of the video data from the camera 90, and may acquire the detection result by identifying the detection result of the first event from among the detection results of the events included in the acquired analysis result of the video data. Alternatively, the detection time determination unit 11 may acquire the detection result of the first event as sensing data from a motion sensor installed in a public space.

Secondly, when the detection result of the first event is acquired from the camera 90 or the motion sensor, the detection time determination unit 11 refers to a table indicating a relevant relationship between the first event and the detection time related to the second event related to the first event. This table may be stored in a storage unit (not illustrated) included in the monitoring device 10, or may be stored in advance in the recording device 80 (FIG. 1) of the system 1.

Thirdly, the detection time determination unit 11 determines a detection time for detecting the second event related to the first event from the video data based on the referred table. The detection time determination unit 11 outputs information indicating the determined detection time to the event detection unit 12.

The first event and the second event will be described. Specifically, the first event is an event that the monitoring person should take some action (at least notice) in accordance with the task. For example, the first event is a person in sleep, carrying away baggage, setting aside and leaving a suspicious object, gathering and enclosing, or sudden stop of an automobile.

Specifically, the second event is an event associated with the first event. The second event is based on the first event and occurs before and after the first event. More particularly, the second event is an event that is a precursor, factor, trigger, or outcome (induced event) of the first event. In an example, the second event is an event that lasts for a long period of time (minutes or more, or hours or more). For example, when the first event is “sudden stop and stagnation of vehicle”, the second event is an event that supports “sudden stop and stagnation of vehicle” as a traffic violation or a traffic accident. In this example, the second event may be “overspeed”, “change in vehicle body shape”, “fallen person”, “traffic jam”, “crowd”. In the first example embodiment, the first event and the second event are associated in advance. However, the monitoring device 10 may also use the learning data to determine a second event associated with the first event (third example embodiment as a specific example).

The event detection unit 12 detects the second event from the video data in the detection time. The event detection unit 12 is an example of an event detection means. When detecting the second event from the video data in the detection time, the event detection unit 12 may further detect a third event associated with the first event and the second event from the video data.

An example of the event detection unit 12 will be described. First, the event detection unit 12 acquires video data. For example, the event detection unit 12 acquires video data from the camera 90 via the network 70 (FIG. 1). As described above, the video data is obtained by the camera 90 capturing the inside of the monitoring target area. The event detection unit 12 receives information indicating the detection time from the detection time determination unit 11.

Secondly, the event detection unit 12 detects the video data in the detection time from the acquired video data. The event detection unit 12 may acquire the video data of the camera in the detection time via the network after receiving the information indicating the detection time from the detection time determination unit 11.

Thirdly, the event detection unit 12 refers to information indicating an association between the first event and the second event. The information indicating the association between the first event and the second event is stored in, for example, a storage unit (not illustrated) of the monitoring device 10. The event detection unit 12 may use information on the second event referred to by the detection time determination unit 11. This eliminates the need to newly refer to the storage unit.

Fourth, the event detection unit 12 detects the second event associated with the first event by using the video data in the detection time and the information on the second event. For example, the event detection unit 12 detects the second event from the video data in the detection time using a learned identifier that identifies the object or the motion related to the second event. Alternatively, the event detection unit 12 may use a related technique such as a background differencing technique and a pattern matching. The means and method for detecting the second event are not limited.

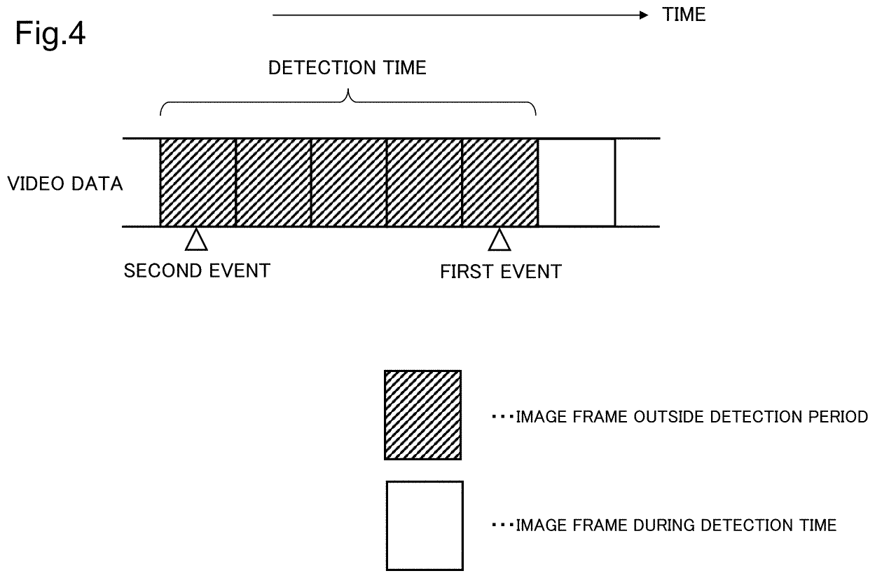

FIG. 4 schematically illustrates an example of video data including a plurality of image frames. As illustrated in FIG. 4, the event detection unit 12 detects the second event from the video data by analyzing the video data. In FIG. 4, hatched portions indicate image frames (five frames) of the video data during the detection time.

Fifth, the event detection unit 12 outputs a flag indicating that the second event is detected from the video data to an external device or the like. Alternatively, the event detection unit 12 may output information indicating a period during which the second event is detected (in an example, one or a plurality of consecutive image frame numbers in the video data) to an external device or the like.

As another example, the event detection unit 12 does not detect the first event from the video data. In this case, the analysis unit of the camera 90 detects the first event from the video data by analyzing the video data. After the first event is detected by the camera 90, the detection time determination unit 11 determines a detection time for detecting a second event before or after the first event in time series from the video data. The event detection unit 12 detects the second event from the video data in the determined detection time. The event detection unit 12 outputs the detection result of the second event to an external device or the like.

### Modification

In one modification, the event detection unit 12 may output a flag indicating that the second event is detected in the video data to an alert unit (not illustrated) of the monitoring device 10 (the fourth example embodiment as a specific example). When acquiring the detection result of the first event from the camera 90, an alert unit (not illustrated) makes a notification of a first alert. Further, the alert unit reports a second alert when a second event is detected. Here, the alert unit may change the notification sound or the display method (color or the like) between the case where the second event is detected and the case where only the first event is detected. As a result, the user (monitoring person) can distinguish between the first alert and the second alert. The alert unit is synchronized with a display control unit (not illustrated) of the monitoring device 10. The display control unit acquires the video data acquired by the event detection unit 12 and displays a video based on the video data on the display. In an example, when the display control unit causes the display to display the image frame in which the second event is detected, the alert unit makes a notification of the second alert.

Alternatively, the alert unit may make a notification of the second alert when receiving a flag indicating that the second event is detected from the event detection unit 12. In this case, the alert unit may continue to make a notification of the second alert until it is detected that the surveillance staff has performed the predetermined stop operation. Alternatively, the alert unit may make a notification of the second alert by a timer for a predetermined period of time.

### Operation of Monitoring Device 10

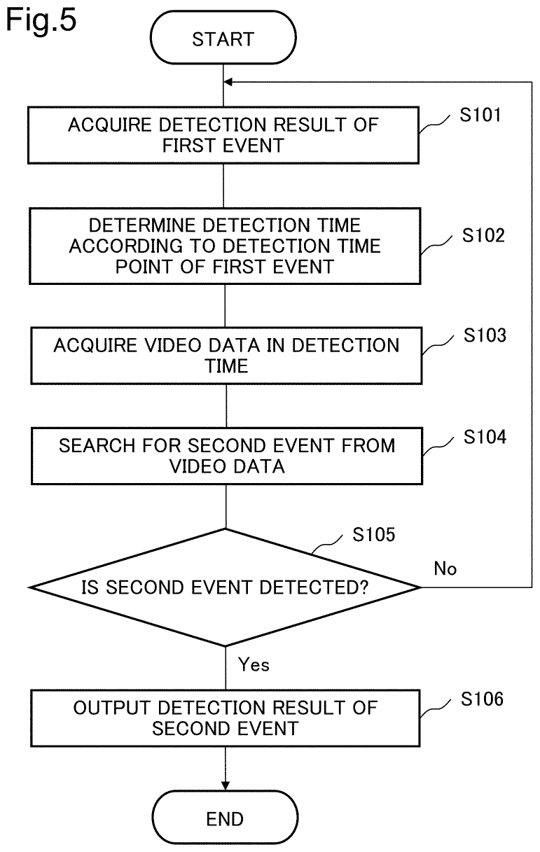

FIG. 5 is a flowchart illustrating an example of a flow of processing executed by each unit of the monitoring device 10 according to the first example embodiment.

As illustrated in FIG. 5, the detection time determination unit 11 acquires the detection result of the first event from the camera 90 (S101). The detection result of the first event includes information indicating a time point at which the camera 90 has detected the first event (referred to as a detection time point of the first event).

The detection time determination unit 11 determines a detection time point according to the detection time of the first event based on the detection result of the first event (S102). The detection time determination unit 11 outputs information indicating the determined detection time to the event detection unit 12.

The event detection unit 12 acquires video data from the camera 90 via the network 70 (S103). The event detection unit 12 receives information indicating the detection time from the detection time determination unit 11.

The event detection unit 12 searches for the second event from the video data in the detection time (S104). When the second event is not detected from the video data in the detection time (No in S105), the flow returns to step S101. On the other hand, when the second event is detected from the video data in the detection time (Yes in S105), the event detection unit 12 outputs a flag indicating that the second event is detected to the external device or the like.

As described above, the operation of the monitoring device 10 according to the first example embodiment ends.

### Effects of Present Example Embodiment

According to the configuration of the present example embodiment, the detection time determination unit 11 determines, based on the time point when the first event is detected from the video data, the detection time for detecting a second event before or after a first event in time series from the video data, and the event detection unit 12 detects the second event from the video data in the detection time. The event detection unit 12 outputs a detection result of the second event. Since the monitoring device 10 can use only the video data in the detection time as the data to be analyzed instead of the entire video data, the processing amount related to the analysis of the video data can be reduced.

### Second Example Embodiment

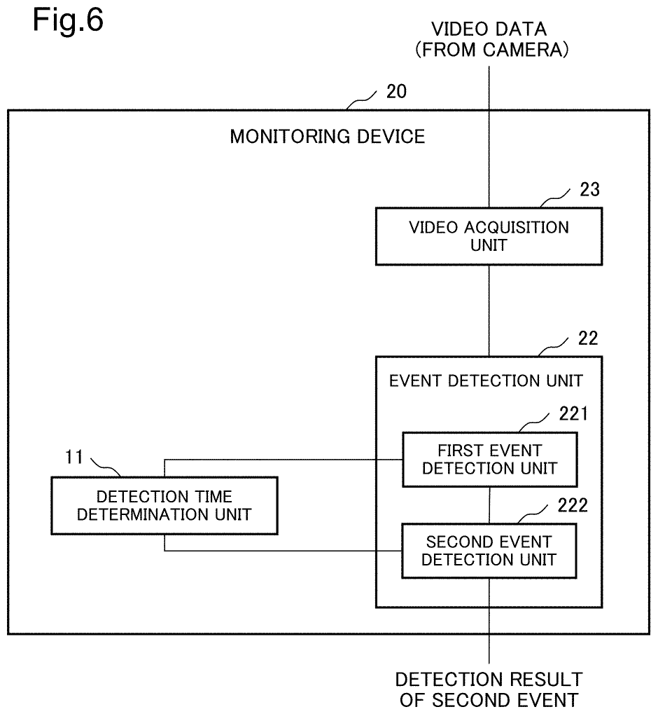

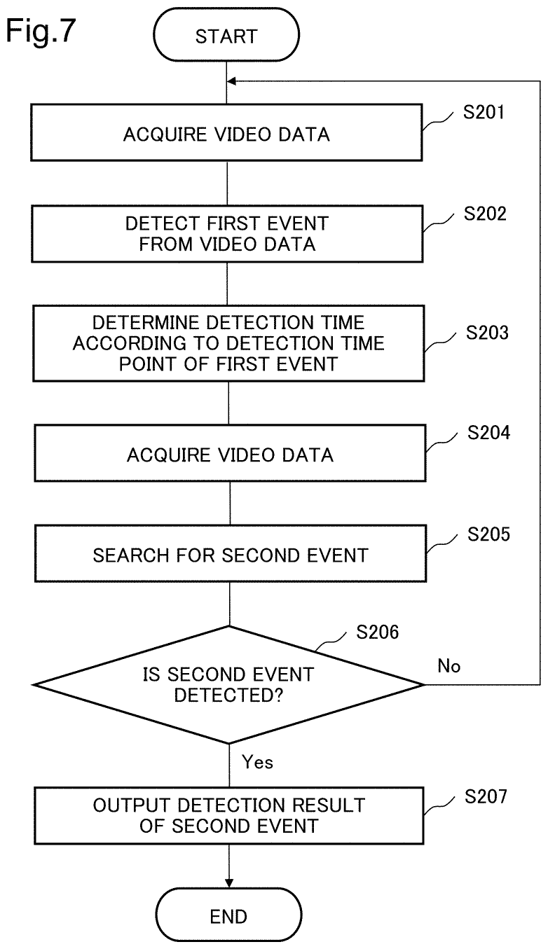

The second example embodiment will be described with reference to FIGS. 6 to 7. Among the components described in the second example embodiment, components assigned the same member numbers as those of the components described in the first example embodiment have the same functions as the components described in the first example embodiment.

### Monitoring Device 20

A configuration of a monitoring device 20 according to the second example embodiment will be described with reference to FIG. 6. FIG. 6 is a block diagram illustrating a configuration of the monitoring device 20.

As illustrated in FIG. 6, the monitoring device 20 includes a video acquisition unit 23, an event detection unit 22, and the detection time determination unit 11. The video acquisition unit 23 according to the second example embodiment acquires video data from the camera 90 via the network 70. The event detection unit 22 detects an event from the video data acquired by the video acquisition unit 23. The event detection unit 22 is an example of an event detection means. When detecting the second event from the video data in the detection time, the event detection unit 22 may further detect a third event associated with the first event and the second event from the video data. The event detection unit 22 is different from the event detection unit 12 described in the first example embodiment in that it includes a first event detection unit 221 and a second event detection unit 222.

The first event detection unit 221 detects the first event from the video data. The first event detection unit 221 is an example of a first event detection means. In an example, the first event detection unit 221 detects the first event from the video data using a learned identifier that identifies an object or a motion related to the first event. Alternatively, the first event detection unit 221 may detect the first event by using a technique for detecting an object by a background differencing technique and a technique for determining an attribute of an object (such as a type or a posture of an object) by pattern matching. However, the means and method for detecting the first event are not limited.

The second event detection unit 222 detects the second event from the video data. The second event detection unit 222 is an example of a second event detection means. In an example, the second event detection unit 222 detects the second event from the video data using a learned identifier that identifies an object or a motion related to the second event. Alternatively, as in the first event detection unit 221, the second event detection unit 222 may use related techniques such as a background differencing technique and a pattern matching. The means and method for detecting the second event are not limited.

### Operation of Monitoring Device 20

FIG. 7 is a flowchart illustrating a flow of processing executed by each unit of the monitoring device 20 according to the second example embodiment.

As illustrated in FIG. 7, first, video acquisition unit 23 acquires video data (S201). The video acquisition unit 23 outputs the acquired video data to each of the first event detection unit 221 and the second event detection unit 222 of the event detection unit 22.

The first event detection unit 221 receives the video data from the video acquisition unit 23. The first event detection unit 221 detects a first event from the received video data (S202).

The first event detection unit 221 outputs information indicating the time point when the first event is detected to the detection time determination unit 11. The first event detection unit 221 also outputs a flag indicating that the first event has been detected to the second event detection unit 222.

The detection time determination unit 11 receives information indicating the time point when the first event is detected from the first event detection unit 221.

The detection time determination unit 11 determines a detection time according to the detection time point of the first event based on the detection result of the first event (S203). The detection time determination unit 11 outputs information indicating the determined detection time to the second event detection unit 222.

The second event detection unit 222 receives a flag indicating that the first event has been detected from the first event detection unit 221. The second event detection unit 222 receives information indicating the detection time from the detection time determination unit 11. The second event detection unit 222 acquires the video data from the video acquisition unit 23 (S204).

The second event detection unit 222 searches for the second event from the video data in the detection time (S205).

When the second event is not detected from the video data in the detection time (No in S206), the flow returns to step S201. On the other hand, when the second event is detected from the video data in the detection time (Yes in S206), the second event detection unit 222 outputs the detection result of the second event to an external device or the like (S207).

Thus, the operation of the monitoring device 20 according to the present the second example embodiment ends.

### Effects of Present Example Embodiment

According to the configuration of the present example embodiment, the detection time determination unit 11 determines, based on the time point when the first event is detected from the video data, the detection time for detecting the second event before or after the first event in time series from the video data, and the event detection unit 22 detects the second event from the video data in the detection time. The event detection unit 22 outputs a detection result of the second event. Since only the video data in the detection time is to be analyzed, the monitoring device 20 can reduce the processing amount related to the analysis of the video data for detecting the second event.

Further, according to the configuration of the present example embodiment, the event detection unit 22 includes the first event detection unit 221 that detects the first event from the video data and the second event detection unit 222 that detects the second event from the video data. Therefore, the monitoring device 30 does not need to obtain the detection result of the first event from the camera 90. In other words, it can also be said that the monitoring device 20 has a function as the analysis unit of the camera 90 described in the first example embodiment.

### Third Example Embodiment

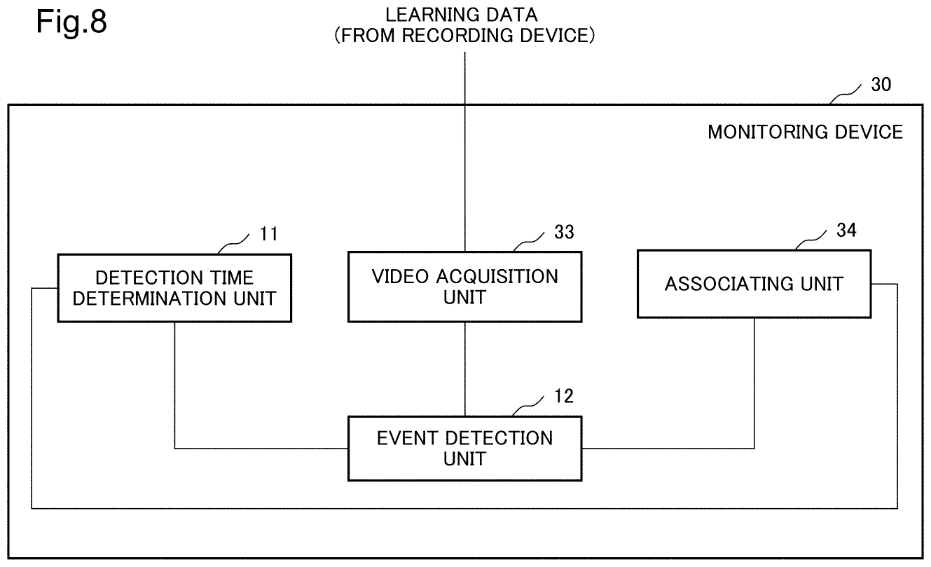

The third example embodiment will be described with reference to FIGS. 8 to 10. Among the components described in the third example embodiment, components assigned the same member numbers as the components described in the first or second example embodiment have the same functions as the components described in the first or second example embodiment.

In the third example embodiment, an example of a method of associating a first event with a second event will be described. For example, if the first event is considered to be a result of a “traffic accident”, the second event may have various causes (factors) such as “signal neglect”, “overspeed”, “distracted driving”, and “meandering driving”. Alternatively, when the first event is considered to be a cause of a “traffic accident”, the second event may have various results such as “change in vehicle body shape”, “fallen person”, and “traffic jam”. In the third example embodiment, there may be a plurality of second events associated with the same first event. Hereinafter, as an example, a case where the second event is the cause and the first event is the result will be described.

### Monitoring Device 30

A configuration of a monitoring device 30 according to the third example embodiment will be described with reference to FIG. 8. FIG. 8 is a block diagram illustrating a configuration of the monitoring device 30.

As illustrated in FIG. 8, the monitoring device 30 includes a video acquisition unit 33, the event detection unit 12, and the detection time determination unit 11. The monitoring device 30 according to the third example embodiment further includes an associating unit 34.

The associating unit 34 associates the first event with the second event. The associating unit 34 is an example of an associating means.

Specifically, video acquisition unit 33 acquires a large number of pieces of video data as learning data. In the third example embodiment, the first event is predetermined. The event detection unit 12 detects the first event and other events from the learning data. The associating unit 34 associates the first event with the second event based on a result of learning of a candidate for the second event that occurs before or after the first event in time series using the learning data. Hereinafter, as an example, a case where the detection time for detecting the second event before the first event in time series is determined will be described.

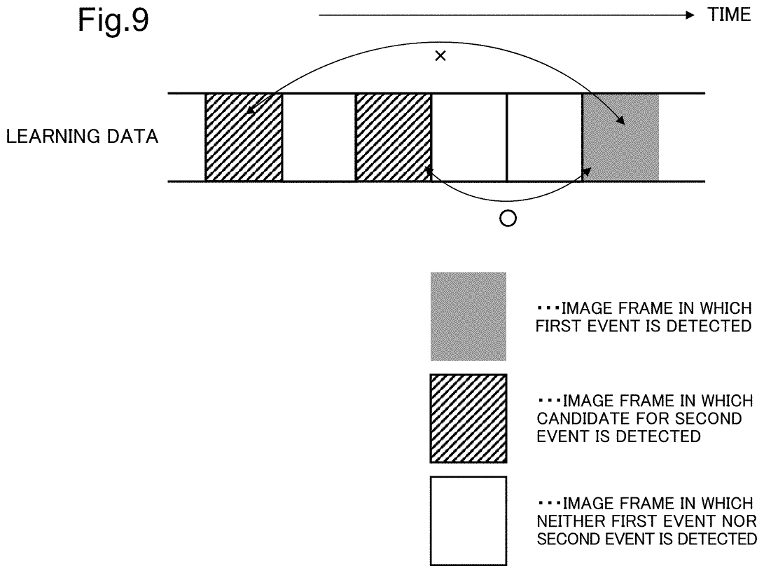

FIG. 9 is a diagram illustrating an example of association between the first event and a candidate for the second event in learning data. As illustrated in FIG. 9, as the time point at which the candidate for the second event is detected is farther in the past direction with respect to the time point at which the first event was detected, the relevance between the candidate for the first event and the second event is smaller. Therefore, the associating unit 34 associates, in the learning data, only the candidate for the second event detected from the video data within a certain period (detection time) in the past direction from the time point when the first event was detected with the first event.

The associating unit 34 calculates a score (an example of the degree of relevance) for the candidate for the second event associated with the first event as described above. In an example, the associating unit 34 calculates the score of the candidate for the second event based on how many pieces of learning data the candidate for the second event has been detected in.

The associating unit 34 determines a second event from one or a plurality of candidates using the score calculated as described above, and associates the first event with the second event. For example, the associating unit 34 associates one or a plurality of candidates whose scores exceed a threshold value as the second event with the first event.

The associating unit 34 outputs information indicating association between the first event and the second event to the detection time determination unit 11 and the event detection unit 12. The information indicating the association between the first event and the second event includes information indicating the time point when the first event is detected in the learning data and information indicating the time point when the second event is detected in the learning data.

The detection time determination unit 11 determines the detection time of the second event based on the information received from the associating unit 34. For example, the detection time determination unit 11 determines the detection time of the second event based on the time from the time point when the second event is detected to the time point when the first event is detected in the learning data. In an example, it is assumed that the times from the time point when the second event is detected to the time point when the first event is detected in the three pieces of video data included in the learning data are A, B, and C. In this case, the detection time determination unit 11 may set the longest one among A, B, and C as the detection time.

The event detection unit 12 detects the second event related to the first event from the video data based on the information received from the associating unit 34 as described in the first example embodiment. Alternatively, as described in the second example embodiment, the event detection unit 12 may detect the first event and the second event from the video data based on the information received from the associating unit 34.

### Operation of Monitoring Device 30

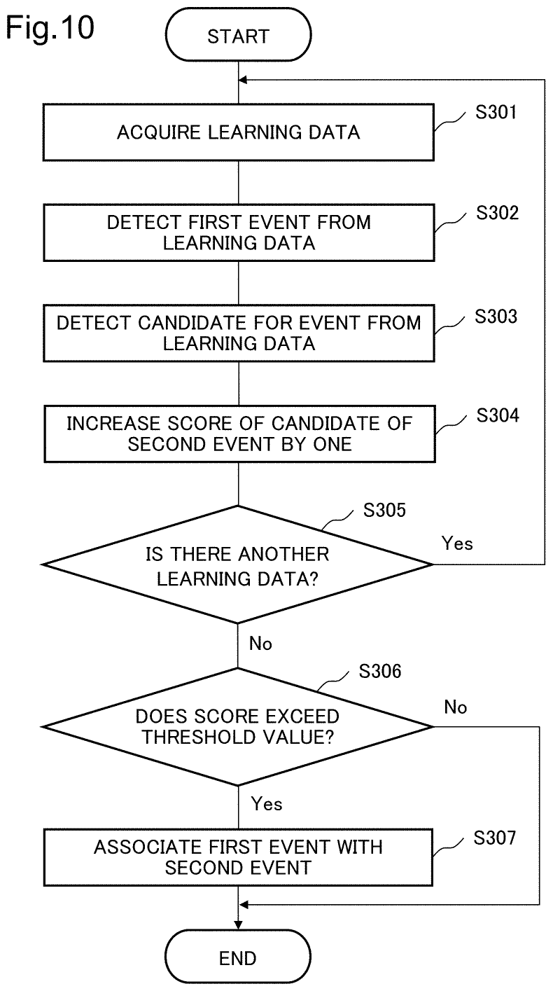

FIG. 10 is a flowchart illustrating a flow of processing executed by the monitoring device 30 according to the third example embodiment.

As illustrated in FIG. 10, first, video acquisition unit 33 acquires learning data (S301). In an example, the video acquisition unit 33 acquires learning data stored in the recording device 80. Video acquisition unit 33 acquires the stored learning data from recording device 80 through network 70. The video acquisition unit 33 outputs the acquired learning data to the event detection unit 12.

The event detection unit 12 receives the learning data from the video acquisition unit 33. The event detection unit 12 detects the first event from the learning data (S302). The event detection unit 12 outputs a flag indicating that the first event has been detected in the learning data to the associating unit 34.

The event detection unit 12 detects a candidate for the second event from the learning data (S303). The event detection unit 12 outputs a flag indicating that a candidate for the second event has been detected in the learning data to the associating unit 34.

The associating unit 34 receives a flag indicating that the first event is detected and a flag indicating that the candidate for the second event is detected from the event detection unit 12. In this case, the associating unit 34 determines the type of the detected candidate of the second event, and increases the score of the determined type of the candidate of the second event by one (S304).

When there is another learning data (Yes in S305), the flow returns to step S301. On the other hand, when there is no other learning data (No in S305), the flow proceeds to step S306.

The associating unit 34 determines whether the score exceeds a threshold value for each type of candidate for the second event (S306).

When the score for the certain candidate type of the second event does not exceed the threshold value (No in S306), the associating unit 34 does not associate the candidate type of the second event as the second event with the first event, and the flow ends. On the other hand, when the score for a certain candidate type of the second event exceeds the threshold value (Yes in S306), the associating unit 34 associates the candidate type of the second event as the second event with the first event (S307). Thereafter, the associating unit 34 outputs information indicating association between the first event and the second event to the event detection unit 12.

The event detection unit 12 detects the second event from the video data using the information received from the associating unit 34 as described in the first example embodiment. Alternatively, as described in the second example embodiment, the event detection unit 12 detects the first event and the second event from the video data.

As described above, the operation of the monitoring device 30 according to the present the third example embodiment ends. When the event detection unit 12 detects a plurality of candidates for the second event from the learning data, the monitoring device 30 executes the above-described process for each candidate for the second event. As a result, a plurality of candidates for the second event may be associated with the first event as the second event.

### Effects of Present Example Embodiment

According to the configuration of the present example embodiment, the detection time determination unit 11 determines, based on the time point when the first event is detected from the video data, the detection time for detecting a second event before or after a first event in time series from the video data, and the event detection unit 12 detects the second event from the video data in the detection time. The event detection unit 12 outputs a detection result of the second event. Since only the video data in the detection time is to be analyzed, the monitoring device 30 can reduce the processing amount related to the analysis of the video data.

Furthermore, according to the configuration of the present example embodiment, the monitoring device 40 further includes the associating unit 34 that associates the first event with the second event. In an example, the associating unit 34 calculates the degree of relevance based on the result of learning the second event candidate as the cause of the first event by using the learning data, and associates the second event candidate having the degree of relevance with the first event exceeding the threshold value as the second event with the first event. As a result, even when the first event and the second event are not associated in advance, the first event and the second event can be associated with each other based on the learning data.

### Fourth Example Embodiment

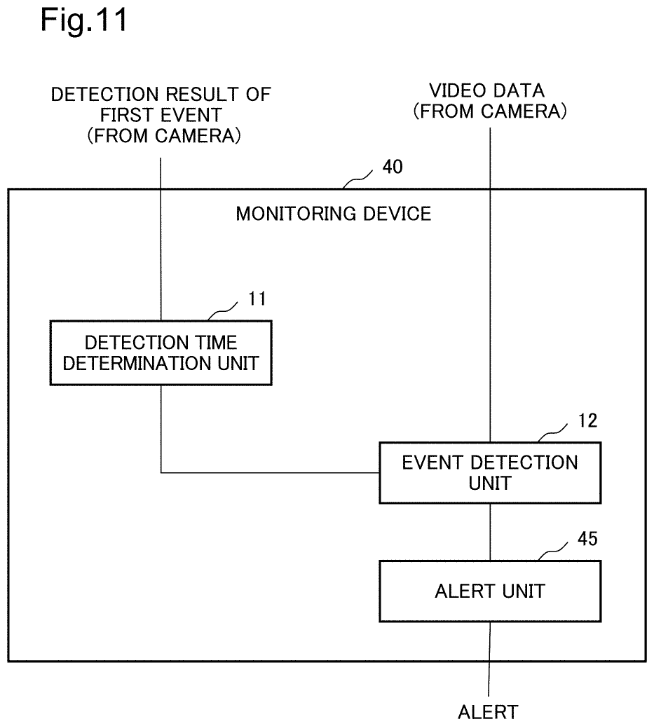

The fourth example embodiment will be described with reference to FIG. 11. Among the components described in the fourth example embodiment, components assigned the same member numbers as those of the components described in any of the first to third example embodiments have the same functions as the components described in any of the first to third example embodiments. The configuration described in the fourth example embodiment can be applied to any of the first to third example embodiments described above.

In a case where the detection result of the first event is acquired from the camera 90, in a case where the first event is detected, and in a case where the second event is detected, an alert unit 45 according to the fourth example embodiment makes a notification of different alerts.

A case where the second event is detected will be described below. In the fourth example embodiment, the event detection unit 12 outputs a flag indicating that the second event is detected in the video data to the alert unit 45. Alternatively, the event detection unit 12 may output information indicating a period during which the second event is detected (in an example, one or a plurality of consecutive image frame numbers in the video data) to the alert unit 45.

The alert unit 45 makes a notification of a first alert when the first event is detected, and makes a notification of a second alert when the second event is detected. The alert unit 45 is an example of an alert means. The alert unit 45 may calculate the estimated processing time of the event detection unit 12 related to the search for the second event and determine whether the estimated processing time of the event detection unit 12 exceeds the maximum processing time allowed by the monitoring device 10. Then, in a case where the estimated processing time of the event detection unit 12 exceeds the maximum processing time allowed by the monitoring device 10, the alert unit 45 may make a notification of the first alert. Further, the alert unit 45 may make a notification of a third alert when a third event associated with the first event and the second event is detected.

In an example, the alert unit 45 is synchronized with a display control unit (not illustrated) of the monitoring device 10. The display control unit acquires the video data acquired by the video acquisition unit 23, and displays a video based on the video data on the display. In an example, when the display control unit causes the display to display the image frame in which the second event is detected, the alert unit 45 makes a notification of the second alert.

Alternatively, the alert unit 45 may make a notification of the second alert when receiving a flag indicating that the second event is detected from the event detection unit 12. In this case, the alert unit 45 may continue to make a notification of the second alert until it is detected that the surveillance staff has performed the predetermined stop operation. Alternatively, the alert unit 45 may make a notification of the second alert by a timer for a predetermined period.

In an example, the (first, second or third) alert is acoustic. In this case, the alert unit 45 may change the volume of the sound related to the second alert according to the time point when the second event is detected. Specifically, the alert unit 45 may make a notification of the second alert at night with a larger volume than during the day.

In other examples, the (first, second or third) alert is an indication. In this case, the alert unit 45 may change the emphasis of the display related to the second alert according to the time point when the second event is detected. Specifically, the alert unit 45 may make a notification of the second alert at night with stronger emphasis than that of daytime.

### Effects of Present Example Embodiment

According to the configuration of the present example embodiment, the detection time determination unit 11 determines, based on the time point when the first event is detected from the video data, the detection time for detecting a second event before or after a first event in time series from the video data, and the event detection unit 12 detects the second event from the video data in the detection time. The event detection unit 12 outputs a detection result of the second event. Since only the video data in the detection time is to be analyzed, the monitoring device 40 can reduce the processing amount related to the analysis of the video data.

According to the configuration of the present example embodiment, the alert unit 45 makes a notification of the first alert when the first event is detected, and makes a notification of the second alert when the second event is detected. Therefore, the monitoring person can quickly take an appropriate response in response to the first or second alert. Further, the alert unit 45 may change the mode of the second alert according to the time point when the second event is detected. As a result, the monitoring person can take an appropriate response based on the mode of the second alert. For example, when the second alert is notified at night, the monitoring person performs monitoring more carefully than when the second alert is notified during the day.

### Hardware Configuration

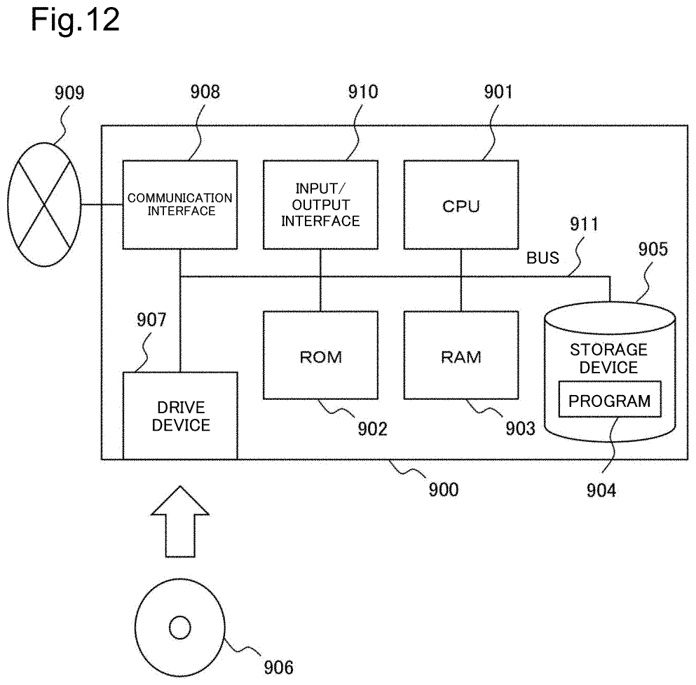

Each component of the monitoring devices 10 to 40 described in the first to fourth example embodiments represents a function-based block. Some or all of these components are implemented by an information processing apparatus 900 as illustrated in FIG. 12, for example. FIG. 12 is a block diagram illustrating an example of a hardware configuration of the information processing apparatus 900.

As illustrated in FIG. 12, the information processing apparatus 900 includes the following configuration as an example.

CPU(Central Processing Unit)901

ROM(Read Only Memory)902

RAM(Random Access Memory)903

program 904 loaded into RAM 903

storage device 905 storing program 904

drive device 907 that reads and writes recording medium 906

communication interface 908 connected to a communication network 909

input/output interface 910 for inputting/outputting data

a bus 911 connecting respective components

Each component of the monitoring devices 10 to 40 described in the first to fourth example embodiments is implemented by the CPU 901 reading and executing a program 904 that implements these functions. The program 904 for achieving the function of each component is stored in the storage device 905 or the ROM 902 in advance, for example, and the CPU 901 loads the program into the RAM 903 and executes the program as necessary. The program 904 may be supplied to the CPU 901 via the communication network 909, or may be stored in advance in the recording medium 906, and the drive device 907 may read the program and supply the program to the CPU 901.

According to the above configuration, each of the monitoring devices 10 to 40 described in the first to fourth example embodiments is achieved as hardware. Therefore, effects similar to the effects described in the first to fourth example embodiments can be obtained.

While the invention has been particularly shown and described with reference to exemplary example embodiments thereof, the invention is not limited to these example embodiments. Various modifications that can be understood by those skilled in the art can be made to the configurations and details of the above example embodiments (and examples) within the scope of the present invention.

### Supplementary Note

Some or all of the above example embodiments may be described as the following Supplementary notes, but are not limited to the following.

### Supplementary Note 1

A monitoring device including:

a detection time determination means configured to determine, based on a time point at which a first event is detected from video data, a detection time for detecting, from the video data, a second event before or after the first event in time series;

and an event detection means configured to detect the second event from the video data in the detection time.

### Supplementary Note 2

The monitoring device according to Supplementary note 1, wherein

the event detection means detects the second event from the video data using an identifier that has performed deep learning.

### Supplementary Note 3

The monitoring device according to Supplementary note 1 or 2, wherein

the event detection means includes a first event detection means configured to detect the first event from the video data and a second event detection means configured to detect the second event from the video data.

### Supplementary Note 4

The monitoring device according to Supplementary note 1 or 2, wherein

the event detection means acquires an analysis result of the video data from a camera, and extracts information indicating a time point at which the camera has detected the first event from the video data from the analysis result of the video data.

### Supplementary Note 5

The monitoring device according to any one of Supplementary notes 1 to 4, further including

an associating means configured to associate the first event with the second event.

### Supplementary Note 6

The monitoring device according to any one of Supplementary notes 1 to 5, further including

an alert means configured to make a notification of a first alert when the first event is detected, and make a notification of a second alert when the second event is detected.

### Supplementary Note 7

The monitoring device according to Supplementary note 6, wherein

the alert means makes a notification of the first alert when an estimated processing time of the event detection means exceeds a maximum processing time allowed by the monitoring device.

### Supplementary Note 8

The monitoring device according to any one of Supplementary notes 1 to 5, wherein

when the event detection means detects the second event from the video data in the detection time, the event detection means further detects a third event associated with the first event and the second event from the video data.

### Supplementary Note 9

The monitoring device according to Supplementary note 8, further including

an alert means configured to make a notification of a third alert when the third event is detected.

### Supplementary Note 10

A monitoring method by a monitoring device, the method including:

determining, based on a time point at which a first event is detected from video data, a detection time for detecting, from the video data, a second event before or after the first event in time series; and

detecting the second event from the video data in the detection time.

### Supplementary Note 11

A non-transitory recording medium storing a program for causing a computer to execute:

determining, based on a time point at which a first event is detected from video data, a detection time for detecting, from the video data, a second event before or after the first event in time series; and

detecting the second event from the video data in the detection time.

### REFERENCE SIGNS LIST

1 system

10 monitoring device

11 detection time determination unit

12 event detection unit

20 monitoring device

22 event detection unit

23 video acquisition unit

221 first event detection unit

222 second event detection unit

30 monitoring device

33 video acquisition unit

34 associating unit

40 monitoring device

45 alert unit

90 camera

What is claimed is:

1. A monitoring device comprising:
a memory configured to store instructions; and
at least one processor configured to execute the instructions to perform:
detecting a first event from video data;
determining, based on information regarding the first event, detection time; and
detecting a second event from the video data, the second event occurred during a period between a first time when the first event is detected and a second time before/after the detection time has passed from the first time.

2-5. (canceled)

6. The monitoring device according to claim 1, further comprising:
the at least one processor is configured to execute the instructions to perform:
making a notification of a first alert when the first event is detected, and making a notification of a second alert when the second event is detected.

7. The monitoring device according to claim 6, wherein
the at least one processor is configured to execute the instructions to perform:
making a notification of the first alert when an estimated processing time exceeds a maximum processing time allowed by the monitoring device.

8-9. (canceled)

10. A monitoring method by a monitoring device, the method comprising:
detecting a first event from video data;
determining, based on information regarding the first event, detection time; and
detecting a second event from the video data, the second event occurred during a period between a first time when the first event is detected and a second time before/after the detection time has passed from the first time.

11. A non-transitory recording medium storing a program for causing a computer to execute:
detecting a first event from video data;
determining, based on information regarding the first event, detection time; and
detecting a second event from the video data, the second event occurred during a period between a first time when the first event is detected and a second time before / after the detection time has passed from the first time.

12. The monitoring device according to claim 1, wherein
the at least one processor is configured to execute the instructions to perform:
determining the detection time based on the first time when the first event is detected.

13. The monitoring device according to claim 1, wherein
the at least one processor is configured to execute the instructions to perform:
determining the detection time based on event type of the first event.

14. The monitoring device according to claim 6, wherein
the at least one processor is configured to execute the instructions to perform:
changing the second alert in response to a third time when the second event is detected.

15. The monitoring method according to claim 10, wherein
the method comprises:
making a notification of a first alert when the first event is detected, and making a notification of a second alert when the second event is detected.

16. The monitoring method according to claim 10, wherein
the method comprises:
making a notification of the first alert when an estimated processing time exceeds a maximum processing time allowed by the monitoring device.

17. The monitoring method according to claim 10, wherein
the method comprises:
determining the detection time based on the first time when the first event is detected.

18. The monitoring method according to claim 10, wherein
the method comprises:
determining the detection time based on event type of the first event.

19. The monitoring device according to claim 15, wherein
the method comprises:
changing the second alert in response to a third time when the second event is detected.

20. The non-transitory recording medium according to claim 11, wherein
the non-transitory recording medium stores the program for causing the computer to execute:
making a notification of a first alert when the first event is detected, and making a notification of a second alert when the second event is detected.

21. The non-transitory recording medium according to claim 11, wherein
the non-transitory recording medium stores the program for causing the computer to execute:
making a notification of the first alert when an estimated processing time exceeds a maximum processing time allowed by the monitoring device.

22. The non-transitory recording medium according to claim 11, wherein
the non-transitory recording medium stores the program for causing the computer to execute:
determining the detection time based on the first time when the first event is detected.

23. The non-transitory recording medium according to claim 11, wherein
the non-transitory recording medium stores the program for causing the computer to execute:
determining the detection time based on event type of the first event.

24. The non-transitory recording medium according to claim 20, wherein
the non-transitory recording medium stores the program for causing the computer to execute:
changing the second alert in response to a third time when the second event is detected.
